(19) United States
(12) Patent Application Publication
(10) Pub. No.: US 2008/0140553 A1
(43) Pub. Date: Jun. 12, 2008

(54) Method of capitalizing a bank or bank holding company

(76) Inventor: Michael W. Kelly, New York, NY (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/635,051

(22) Filed: Dec. 7, 2006

(51) Int. Cl. G06Q 40/00

(52) U.S. Cl. 705/35

(57) ABSTRACT

The present invention is directed to a method of capitalizing a bank holding company by, for example, providing a capital structure for the bank holding company that includes multiple tranches of one or more series of common stock, each tranche corresponding to one of a number of classes of ownership rights in the bank holding company. Each share of common stock associated with one or more of the tranches will have a capped dividend paid out at a predetermined rate whose value is dependent on the particular one of the tranches that the share of common stock is associated with.

### BACKGROUND OF THE INVENTION

1. Field of the Invention

The present invention relates generally to the financing of banking related entities. In particular, the present invention is directed to a method of capitalizing a bank or bank holding company.

2. Description of Related Art

The capitalization of banks and bank holding companies is highly regulated at the federal and state level to ensure that minimum capital requirements are met or exceeded by those entities. By way of example, the Bank Holding Company Act of 1956, as amended, and as implemented by the Federal Reserve Board, provides capital adequacy guidelines that ensure that bank holding companies adhere to minimum capital asset standards. The challenge is to provide a capital structure for a bank holding company that meets these guidelines while still offering investors a diverse set of investment options that allow them to take on different levels of risk and reward. Similar guidelines apply to federally insured banks regulated by the Federal Reserve, the Controller of the Currency and the FDIC.

One vehicle that often satisfies a diverse set of investment criteria is the collateralized debt obligation (CDO), which is an investment grade security that is backed by a pool of assets, such as bonds. CDOs represent diverse types of debt and credit risks. The different types of debt associated with CDOs are referred to as “tranches”, with each tranche having a different maturity and risk associated with it. CDOs pay more for investors who are willing to assume greater risk.

The present invention described below provides a capital structure for a bank or bank holding company that accounts for the regulatory restraints placed on those entities while at the same time offering an investment vehicle similar to a CDO that attracts investors with different risk and reward profiles.

### SUMMARY OF THE INVENTION

In accordance with an exemplary embodiment of the invention, a method is provided for capitalizing a bank holding company. The exemplary method includes the act of providing a capital structure for the bank holding company that includes multiple tranches of one or more series of common stock, each tranche corresponding to one of a number of classes of ownership rights in the bank holding company. Each share of common stock associated with one or more of the tranches will have a capped dividend paid out at a predetermined rate whose value is dependent on the particular one of the tranches that the share of common stock is associated with.

### BRIEF DESCRIPTION OF THE DRAWINGS

FIG. 1 is a diagram of entities involved in the capitalization of a bank and bank holding company.

FIG. 2 is a diagram showing a capital structure that may be employed for a bank or bank holding company in accordance with the present invention.

### DESCRIPTION OF PREFERRED EMBODIMENTS OF THE INVENTION

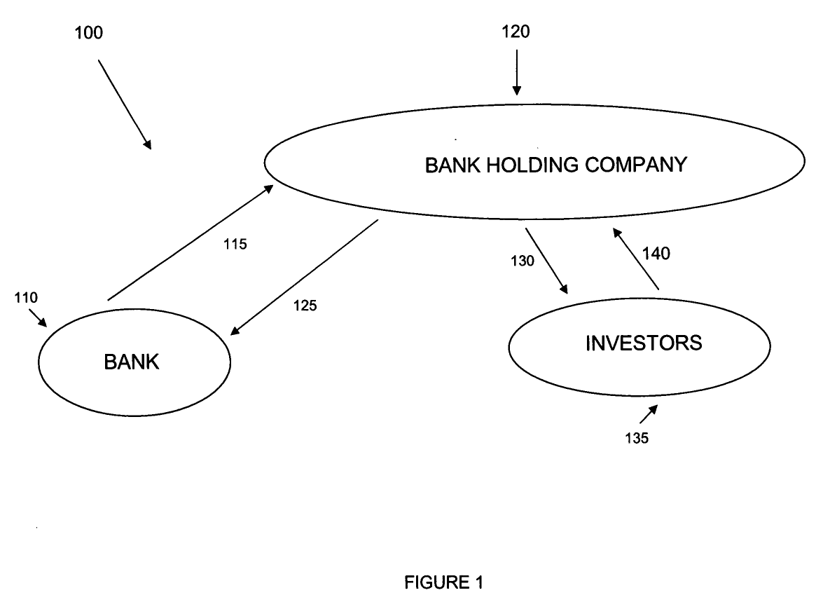

FIG. 1 depicts entities 100 involved in the capitalization of a bank 110 or bank holding company 120. The bank 110 issues 115 a predetermined number of equity instruments to a bank holding company 120 and receives 125 funds in return. All of the bank's 110 equity instruments may be held by the bank holding company 120 and the equity instruments may be common stock or a series of common stock. By way of example, the bank 110 may issue a particular number (e.g., 1.5 million) of shares of common stock at a specified par value (e.g., $10.00).

The bank 110 may also issue subordinated debt (not shown) to be included in its Tier 2 capital. The subordinated debt may have a minimum period of maturity (e.g., a five-year minimum maturity). The subordinated debt may (i) be subordinated in right of payment to the bank's 110 obligations to its depositors and to the bank's 110 other obligations to its general and secured creditors, (ii) be ineligible as collateral for a loan by the issuing bank, (iii) be unsecured, (iv) state that the bank 110 may not retire any part of its obligation without the prior written consent of the bank's primary federal regulator (e.g., FDIC), and (v) will include a specific waiver of the right of offset by the lending depository institution (if the obligation is issued to a depository institution).

The bank holding company 120 may issue 130 equity instruments to investors 135 to raise 140 funds. In particular, equity instruments may be issued to qualified institutional investors through a private placement so that instruments will not have to be registered with the Securities and Exchange Commission. The qualified institutional investors will, in the aggregate, commit contractually to pay into the bank holding company 120 a predetermined amount over a predetermined period of time.

By way of example, the qualified institutional investors may pay approximately $350 million over the course of the first three years of the bank holding company's 120 operations. These contracts will be binding subscription agreements and the bank holding company 120 will have the right to call any amount when needed, with the full predetermined amount being called by the end of the predetermined period of time (measured for example, from the start of the bank holding company's 120 operations). Once the bank holding company 120 decides to call an amount, the qualified institutional investors will be required to pay that amount into the bank holding company 120.

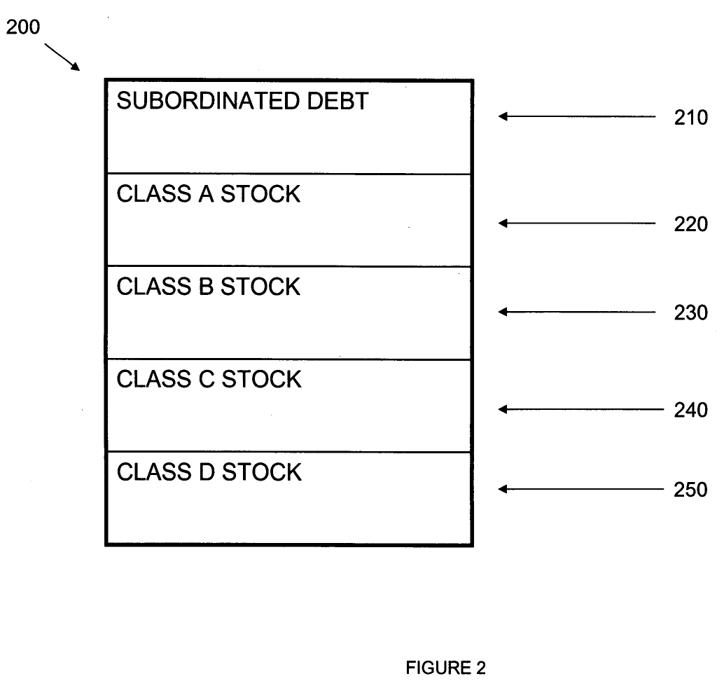

In accordance with a preferred embodiment of the present invention, the bank holding company's 120 capital structure 200 consists of multiple tranches of common stock 220, 230, 240 and 250, as shown in FIG. 2. The capital structure 200 includes four tranches of common stock, including Class A common stock 220, Class B common stock 230, Class C common stock 240 and Class D common stock 250. However, the capital structure 200 may be modified to include more or less than four tranches of common stock. In addition, the capital structure 200 may be modified to include tranches of other types of instruments including equity instruments (such as preferred stock) or a series of instruments (such as a series of common stock). As an alternative, the capital structure 200 of the bank holding company 120 may be used for the capital structure of the bank 110.

All tranches of common stock 220, 230, 240 and 250 of the bank holding company 120 will be voting shares, and each tranche of common stock will vote together as a class, and are intended to comprise a single “class” of voting securities for regulatory purposes.

At least upon issuance, the common stock associated with one tranche may have a different risk than the common stock associated with any of the other tranches. This ensures that investors will have different investment options that offer different rates of return. The higher risk tranches offer greater reward for greater risk taking on the part of the investor.

One or more tranches of common stock 220, 230, 240 and 250 will have a capped dividend paid out at a specified rate. The rate may have a value that is dependent on the particular one of the tranches 220, 230, 240 and 250 that the common stock is associated with. The capped dividend provides investors with a yardstick for gauging the rate of return that they are likely to receive over time from the corresponding instrument and is analogous to a coupon rate for a bond. However, the dividend will be paid out only if there is a determination made by the board of directors of the bank holding company to do so. Although the board of directors usually intend for the bank holding company to pay out a dividend, the bank holding company is generally not under an obligation to pay out such a dividend in any given year.

By way of example, if the bank holding company 120 issues four tranches of common stock 220, 230, 240 and 250, as shown in FIG. 2, it may issue a specific number (e.g., 45,000) of shares of Class A common stock 220 with a particular par value (e.g., $1.00) per share and with a particular subscription price (e.g., $1,000) per share. The Class A common stock 220 cannot be made convertible into any other class of security and does not have any anti-dilution rights. In addition, each share entitles the holder thereof to an equal vote with other classes of common stock in the election of directors of the bank holding company. The Class A common stock 220 may have a cumulative and/or capped dividend at the London Interbank Offered Rate (“LIBOR”) plus twenty-five points. LIBOR is an interest rate at which banks can borrow funds from other banks in the London inter-bank market. In accordance with at least one embodiment of the present invention, the dividend is not cumulative. As noted above, the dividend will be paid only if there is a determination made by board of directors to do so, as the bank holding company is generally not under an obligation to pay out a dividend in any given year. The Class A common stock 220 may be entitled to cumulative voting such that each shareholder is entitled one vote per share times the number of directors to be elected. The Class A common stock 220 will be junior to any subordinated debt and senior to the Class B, Class C, and Class D common stock 230, 240 and 250 described in greater detail below.

The bank holding company 120 may also authorize and issue a specific number (e.g., 90,000) of shares of Class B common stock 230 with a particular par value (e.g., $1.00) per share and with a particular subscription price (e.g., $1,000) per share. The Class B common stock 230 cannot be made convertible into any other class of security and does not have any anti-dilution rights. In addition, each share entitles the holder thereof to an equal vote with other classes of common stock in the election of directors of the bank holding company 120. The Class B common stock may have a cumulative and/or capped dividend at LIBOR plus one-hundred points. In accordance with at least one embodiment of the present invention, the dividend is not cumulative. As noted above, the dividend will be paid only if there is a determination made by board of directors to do so, as the bank holding company is generally not under an obligation to pay out a dividend in any given year. The Class B common stock 230 will be junior to any subordinated debt and to any Class A common stock 220. However, the Class B common stock 230 will be senior to any Class C and/or Class D common stock 240 and 250.

The bank holding company may also authorize and issue a specific number (e.g., 150,000) of shares of Class C common stock 240 with a particular par value (e.g., $1.00) per share and with a particular subscription price (e.g., $1,000.00) per share. The Class C common stock 240 cannot be made convertible into any other class of security and does not have any anti-dilution rights. In addition, each share entitles the holder thereof to an equal vote with other classes of common stock in the election of directors of the bank holding company 120. The Class C common stock 240 may have a cumulative and/or capped dividend at LIBOR plus three-hundred and fifty points. In accordance with at least one embodiment of the present invention, the dividend is not cumulative. As noted above, the dividend will be paid only if there is a determination made by board of directors to do so, as the bank holding company is generally not under an obligation to pay out a dividend in any given year. The Class C common stock 240 will be junior to the subordinated debt and to any Class A and/or any Class B common stock 220 and 230. However, the Class C common stock 240 will be senior to any Class D common stock 250.

The bank holding company may also authorize and issue a specific number (e.g., 80,000) of shares of Class D common stock 250 with a particular par value (e.g., $1.00) per share and with a particular subscription price (e.g., $1,000) per share. The Class D common stock 250 cannot be made convertible into any other class of security and does not have any anti-dilution rights. In addition, each share entitles the holder thereof to an equal vote with other classes of common stock in the election of directors of the bank holding company 120. The Class D Common Stock 250 may have a cumulative and/or non-capped dividend. In accordance with at least one embodiment of the present invention, the dividend is not cumulative. The dividend on the Class D common stock 250 will be junior to the subordinated debt and any Class A, Class B, and/or Class C common stock 220, 230 and 240.

As shown in FIG. 2, the bank holding company may also issue debt 210 (e.g., subordinated debt) that has a minimum maturity period (such as five-years) and other appropriate terms to be included in its Tier 2 capital. The debt 220 may be unsecured and may be subordinated in right of payment to the claims of the bank holding company's 120 general creditors. In addition, the debt 220 will not have credit-sensitive features, will not contain covenants, terms, and restrictions that are inconsistent with safe and sound banking practices, and will not contain provisions that permit the holder to accelerate payment of principal prior to maturity except in the event of bankruptcy or the appointment of a receiver for the bank holding company 120.

Although different embodiments of the present invention have been discussed, those skilled in the art will appreciate that variations may be made thereto without departing from the principles of the present invention. In addition, although the preferred embodiment has been described to include a number of features, a method may be developed which does not include all of those features, and yet still falls within the spirit and scope of the present invention.

What is claimed is:

1. A method of capitalizing a bank holding company comprising the act of:
raising capital for the bank holding company via the issuance of a plurality of equity instruments, each of said equity instruments corresponding to one of a plurality of classes of ownership rights in said bank holding company, wherein each equity instrument associated with one or more of said classes will have a capped dividend paid out at a predetermined rate whose value is dependent on the particular one of said classes that the equity instrument is associated with.

2. The method defined by claim 1, wherein each holder of an equity instrument of said plurality of equity instruments that is associated with at least one of said classes is entitled to one vote per share times a number of directors to be elected.

3. The method defined by claim 1, wherein holders of equity instruments associated with each of said plurality of classes are entitled to vote together as a class of voters.

4. The method defined by claim 1, wherein said capped dividend is also a cumulative dividend.

5. The method defined by claim 1, wherein said capped dividend is a function of the London Interbank Offered Rate.

6. The method defined by claim 1, wherein equity instruments associated with each one of said classes are reflective of different risks than those that are inherent in equity instruments of any other of said classes.

7. The method defined by claim 1, wherein said equity instruments comprise common stock.

8. The method defined by claim 1, wherein said equity instruments comprise at least one series of common stock.

9. The method defined by claim 1, wherein said equity instruments comprise preferred stock.

10. The method defined by claim 1, wherein each equity instrument associated with each one of said plurality of classes is not convertible into any other class of said plurality of classes.

11. The method defined by claim 1, further comprising the step of issuing debt of said bank holding company.

12. The method defined by claim 11, wherein said debt is unsecured and subordinated in right of payment to the claims of the bank holding company's general creditors.

13. A method of capitalizing a bank holding company comprising the act of:
providing a capital structure for the bank holding company comprising a plurality of tranches of one or more types of equity instruments, each tranche of said plurality of tranches corresponding to one of a plurality of classes of rights in said bank holding company, wherein each equity instrument associated with one or more of said tranches will have a capped dividend paid out at a predetermined rate whose value is dependent on the particular one of said tranches that the equity instrument is associated with.

14. The method defined by claim 13, wherein each holder of an equity instrument of said plurality of equity instruments that is associated with at least one of said plurality of tranches is entitled to one vote per share times a number of directors to be elected.

15. The method defined by claim 13, wherein holders of equity instruments associated with each one of said tranches are entitled to vote together as a class of voters.

16. The method defined by claim 13, wherein said capped dividend is also a cumulative dividend.

17. The method defined by claim 13, wherein said capped dividend is a function of the London Interbank Offered Rate.

18. The method defined by claim 13, wherein said equity instruments comprise common stock.

19. The method defined by claim 13, wherein said equity instruments comprise at least one series of common stock.

20. The method defined by claim 13, wherein said equity instruments comprise preferred stock.

21. The method defined by claim 13, wherein each equity instrument associated with each one of said tranches is not convertible into any other tranche of said tranches.

22. The method defined by claim 13, further comprising the step of issuing debt of said bank holding company.

23. The method defined by claim 22, wherein said debt is unsecured and subordinated in right of payment to the claims of the bank holding company's general creditors.

24. A method of capitalizing a bank holding company comprising the act of:
providing a capital structure for the bank holding company comprising a plurality of tranches of one or more series of common stock, each tranche corresponding to one of a plurality of classes of ownership rights in said bank holding company;
wherein each share of common stock associated with one or more of said tranches will have a capped dividend paid out at a predetermined rate whose value is dependent on the particular one of said tranches that the share of common stock is associated with.

25. The method defined by claim 24, wherein each holder of an equity instrument of said plurality of equity instruments that is associated with at least one of said plurality of tranches is entitled to one vote per share times a number of directors to be elected.

26. The method defined by claim 24, wherein holders of equity instruments associated with each one of said tranches are entitled to vote together as a class of voters.

27. The method defined by claim 24, wherein said capped dividend is also a cumulative dividend.

28. The method defined by claim 24, wherein said equity instruments comprise common stock.

29. The method defined by claim 24, wherein said equity instruments comprise at least one series of common stock.

30. The method defined by claim 24, wherein said equity instruments comprise preferred stock.

31. The method defined by claim 24, wherein each equity instrument associated with each one of said tranches is not convertible into any other tranche of said tranches.

32. The method defined by claim 24, further comprising the act of issuing debt of the bank holding company.

33. The method defined by claim 32, wherein said debt is unsecured and subordinated in right of payment to the claims of the bank holding company's general creditors.
